(19) United States
(12) Patent Application Publication
(10) Pub. No.: US 2026/0032199 A1
(43) Pub. Date: Jan. 29, 2026

(54) METHOD FOR COLLECTING OPERATION HISTORY OF IMAGE FORMING APPARATUS, IMAGE FORMING SYSTEM AND SERVER COMPUTER

(71) Applicant: CANON KABUSHIKI KAISHA, Tokyo (JP)

(72) Inventors: HIROKO KUNIMOTO, Kanagawa (JP); KOICHI SUZUKI, Kanagawa (JP); DAISUKE MOMIYAMA, Shizuoka (JP); MASAKI KOBAYASHI, Shizuoka (JP); KAORU TSUNODA, Shizuoka (JP)

(21) Appl. No.: 19/274,017

(22) Filed: Jul. 18, 2025

(30) Foreign Application Priority Data
Jul. 24, 2024 (JP) 2024-118761

(51) Int. Cl. H04N 1/00

(52) U.S. Cl. CPC H04N 1/00039; H04N 1/0009; H04N 1/00477; H04N 2201/0094

(57) ABSTRACT

An image forming system obtains an operation history of an image forming apparatus and data pertaining to a state or a type of the image forming apparatus, accumulates the operation history and the data obtained. The system is further configured to: determine, based on the data, whether to execute an analysis using the operation history accumulated in the storage device; execute the analysis in a case where the analysis is determined to be executed, and skip the analysis in a case where the analysis is determined not to be executed; and provide a notification of an analysis result that is a result of the analysis.

### BACKGROUND

### Field of the Technology

The present disclosure relates to a method for collecting an operation history of an image forming apparatus, an image forming system and a server computer.

### Description of the Related Art

Image forming apparatuses have consumables that require maintenance. It is therefore necessary to notify a user or administrator of a printer of the need for maintenance at appropriate times. Japanese Patent Laid-Open No. 2021-071657 proposes changing the timing for a notification prompting maintenance to be performed is output by improving an analysis method on the basis of results of analyzing an operation history. Meanwhile, Japanese Patent Laid-Open No. 2017-049759 proposes determining whether maintenance is necessary in consideration of a degree of fault tolerance for each image forming apparatus.

These background techniques focus on determining whether maintenance is necessary on the basis of an operation history collected from the printer. In other words, the techniques are aimed at improving the accuracy of notifications. However, there are cases where, depending on the collected operation history, the analysis itself is unnecessary. For example, if an image forming apparatus is new, the consumables thereof have not yet deteriorated, and notifications about the consumables will therefore almost never be needed. In other words, the operation history need not be analyzed. In such a case, sending the operation history from the printer to an analysis server, having an analysis server analyze the operation history, and other such operations will waste energy. In addition, storing operation histories which need not be analyzed in a server will needlessly take up storage space in that server.

### SUMMARY

The present disclosure provides an image forming system comprising: at least one processor configured to obtain an operation history of an image forming apparatus and data pertaining to a state or a type of the image forming apparatus; and a storage device configured to accumulate the operation history and the data obtained, wherein the at least one processor is further configured to: determine, based on the data, whether to execute an analysis using the operation history accumulated in the storage device; execute the analysis in a case where the analysis is determined to be executed, and skip the analysis in a case where the analysis is determined not to be executed; and provide a notification of an analysis result that is a result of the analysis.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view of an image forming apparatus.

FIGS. 2A to 2C are cross-sectional views of a feed section.

FIGS. 3A and 3B are graphs illustrating variation in a feed time.

FIG. 4 is a diagram illustrating hardware.

FIG. 5 is a diagram illustrating functions.

FIGS. 6A to 6D are diagrams illustrating tables.

FIGS. 7A and 7B are flowcharts illustrating a method for controlling an image forming apparatus.

FIG. 8 is a flowchart illustrating a method for controlling a server apparatus.

FIG. 9 is a diagram illustrating functions.

FIG. 10 is a diagram illustrating a user interface.

FIGS. 11A and 11B are diagrams illustrating a database.

FIG. 12 is a flowchart illustrating a control method for an image forming apparatus.

FIGS. 13A and 13B are flowcharts illustrating a method for controlling a server apparatus.

FIG. 14 is a diagram illustrating functions.

FIGS. 15A and 15B are flowcharts illustrating a method for controlling an image forming apparatus and a server apparatus.

FIG. 16 is a diagram illustrating functions.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Image Forming Apparatus

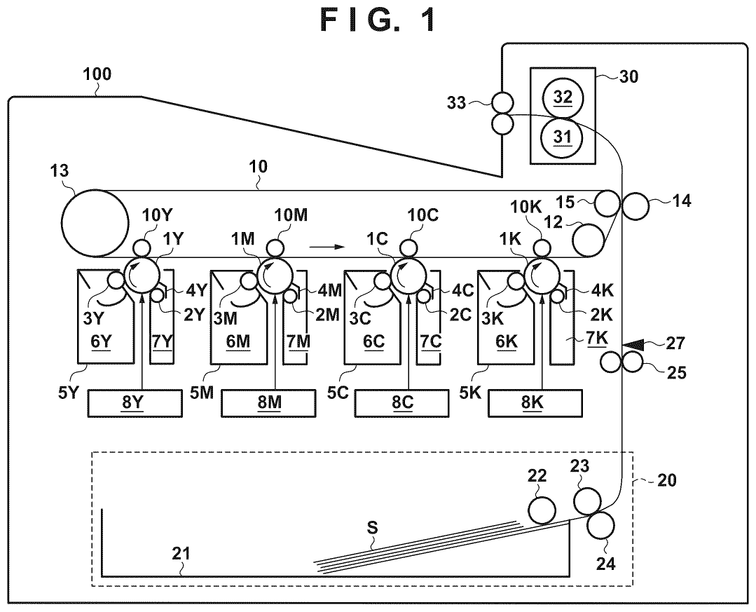

As illustrated in FIG. 1, a printer 100 is an electrophotographic image forming apparatus. However, the electrophotographic method is merely one example, and another recording method, such as the ink jet recording method and the thermal transfer method, may be used instead. The printer 100 outputs a color image by superimposing toners of four colors, namely yellow (Y), magenta (M), cyan (C), and black (K). Although the letters Y, M, C, and K are appended to the reference signs in FIG. 1, those letters will be omitted from the reference signs when describing items common to all four colors.

A process cartridge 5 includes a toner receptacle 6 that holds the toner. The process cartridge 5 also includes a photosensitive drum 1, which is an image carrier. Furthermore, the process cartridge 5 includes a charging roller 2, a developing roller 3, a cleaning blade 4, and a waste toner receptacle 7.

The photosensitive drum 1 rotates in the direction indicated by the arrow. A predetermined negative-polarity voltage (a charging voltage) is applied to the charging roller 2, which charges the surface of the photosensitive drum 1 to a predetermined negative-polarity potential. A laser unit 8 is disposed below the process cartridge 5. The laser unit 8 is an exposure apparatus or an optical scanning apparatus that forms an electrostatic latent image by irradiating the photosensitive drum 1 with light based on an image signal. The developing roller 3 forms a toner image corresponding to the electrostatic latent image by causing the developing agent (toner) supplied from the toner receptacle 6 to adhere to the image carrier. Note that a predetermined negative-polarity voltage (a developing voltage) is applied to the developing roller 3 to promote the developing.

An intermediate transfer member unit is constituted by an intermediate transfer member 11, a drive roller 12, a tension roller 13, and an opposing roller 15. The intermediate transfer member 11 is an endless belt (an intermediate transfer belt), for example. The drive roller 12 is a roller that rotates the intermediate transfer member 11. The tension roller 13 and the opposing roller 15 are rollers which are rotated by the intermediate transfer member 11.

A primary transfer roller 10 is provided on an inner side of the intermediate transfer member 11 opposite the photosensitive drum 1. A transfer voltage for promoting the transfer of the toner image is applied to the primary transfer roller 10. When the photosensitive drum 1 rotates, the toner image on the photosensitive drum 1 is conveyed to a primary transfer nip. The primary transfer nip is located at the position where the photosensitive drum 1 and the primary transfer roller 10 are opposite each other. The primary transfer roller 10 transfers the toner image from the photosensitive drum 1 to the intermediate transfer member 11. Through this, each of the Y, M, C, and K toner images is superimposed on the intermediate transfer member 11, producing a full-color image. The cleaning blade 4 is a cleaning member that cleans the toner remaining on the photosensitive drum 1 and collects that toner in the waste toner receptacle 7. A feed section 20 is constituted by a feed cassette 21, a feed roller 22, a conveyance roller 23, a separation roller 24, and the like. The feed cassette 21 holds a plurality of sheets S. The feed roller 22 feeds a sheet S from the feed cassette 21 into a conveyance path. The conveyance roller 23 conveys the sheet S further downstream in the conveyance path. The separation roller 24 is a roller that separates a single sheet S from the plurality of sheets S.

A registration roller pair 25 is disposed further downstream from the feed section 20 in the conveyance path. The registration roller pair 25 corrects skew in the sheet S conveyed from the feed section 20, and conveys the sheet S further downstream. A sheet sensor 27 is disposed downstream from the registration roller pair 25. The sheet sensor 27 detects the arrival of a leading edge of the sheet S, detects the timing at which a trailing edge of the sheet S passes, and the like.

A secondary transfer roller 14 is provided further downstream from the registration roller pair 25. The secondary transfer roller 14 is disposed opposite the opposing roller 15, and forms a secondary transfer nip in tandem with the intermediate transfer member 11. The secondary transfer roller 14 transfers the toner image from the intermediate transfer member 11 to the sheet S. To facilitate the transfer of the toner image, a positive-polarity voltage (a secondary transfer voltage) is applied to the secondary transfer roller 14.

A fixing apparatus 30 is disposed downstream from the secondary transfer nip. The fixing apparatus 30 includes a fixing film 31 and a pressure roller 32, and fixes the toner image onto the sheet S by applying heat and pressure to the sheet S and the toner image. A discharge roller pair 33 is provided downstream from the fixing apparatus 30. The discharge roller pair 33 discharges the sheet S to the exterior of the printer 100.

A detection result from the sheet sensor 27 is used to determine whether the sheet S has arrived early or late. “Arriving early” refers to the sheet S arriving at the sheet sensor 27 earlier than the expected timing. “Arriving late” refers to the sheet S arriving at the sheet sensor 27 later than the expected timing. These phenomena may be called “conveyance errors”. A jam of the sheet S is determined to have occurred when the sheet sensor 27 cannot detect the sheet S even after the feed roller 22 retries the feeding. Although FIG. 1 illustrates the sheet sensor 27 being installed in association with the registration roller pair 25, this is merely one example. Separate sheet sensors 27 may be provided on the downstream side of the secondary transfer nip and the downstream side of the fixing apparatus 30, respectively. Jams at the secondary transfer nip and jams in the fixing apparatus 30 may be detected through this configuration.

### 2. Feed Section

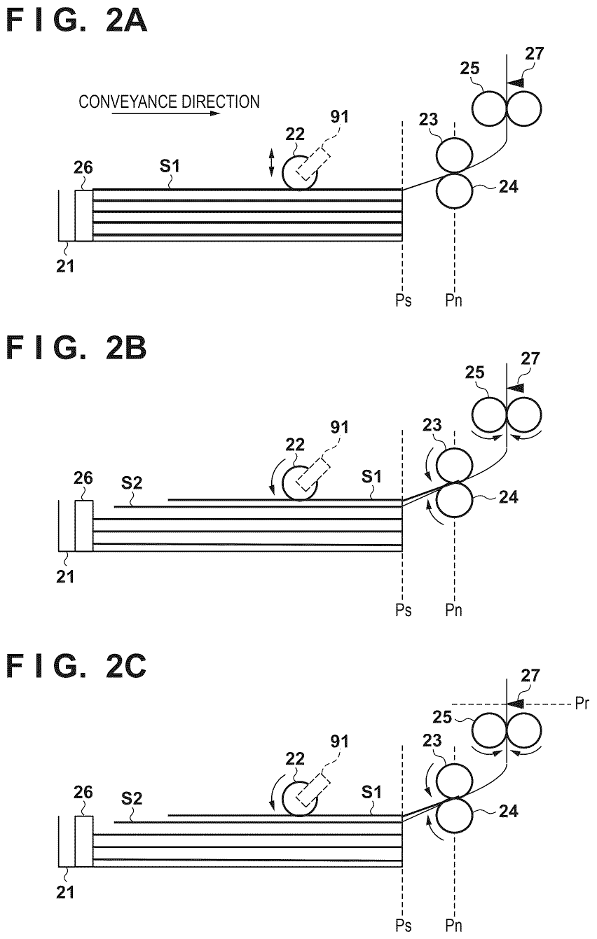

FIGS. 2A to 2C illustrate feed operations performed by the feed section 20. As illustrated in FIG. 2A, when the solenoid 91 lowers the feed roller 22, a sheet S1, which is the uppermost of the plurality of sheets S held in the feed cassette 21, is fed into the conveyance path by the feed roller 22. The plurality of sheets S in the feed cassette 21 are positioned by a trailing edge regulation plate 26. The trailing edge regulation plate 26 is configured to freely move in both a conveyance direction and the direction opposite thereto. The user changes the installation position of the trailing edge regulation plate 26 as appropriate in accordance with the size of the sheet S. The user pulls out the feed cassette 21 and refills the sheets S, changes the size of the sheets S, changes the installation position of the trailing edge regulation plate 26, and the like.

When the trailing edge regulation plate 26 is installed such that the trailing edge regulation plate 26 contacts the trailing edge of the sheet S, the leading edge of the sheet S1 is located at a conveyance start position Ps. When the feed operation is started, the feed roller 22 and the conveyance roller 23 both rotate. The sheet S1 moves to the right (the conveyance direction) due to friction between the feed roller 22 and the sheet S1.

As illustrated in FIG. 2B, the sheet S1 reaches a separation nip Pn formed by the conveyance roller 23 and the separation roller 24. Friction also acts between the sheet S1 and a sheet S2 located under the sheet S1. Accordingly, the sheet S2 may also move in the conveyance direction. When at least two sheets S are conveyed to the separation nip Pn by the feed roller 22, the separation nip Pn separates one sheet S from the at least two sheets S and conveys the one sheet S downstream. A torque limiter (not shown) is connected to the separation roller 24. A predetermined torque is applied to the separation roller 24. As a result, the separation roller 24 applies resistance to the sheet S2 in a direction opposite from the conveyance direction of the sheet S1. This torque is set such that the separation roller 24 is rotated along with the conveyance roller 23 when there is one sheet S at the separation nip Pn, and the separation roller 24 is stopped when at least two sheets S enter the separation nip Pn. Accordingly, the separation nip Pn can separate and convey the sheets S one at a time.

The feed roller 22 and the conveyance roller 23 continue to rotate thereafter. As illustrated in FIG. 2C, the sheet S1 passes through the registration roller pair 25. As a result, the leading edge of the sheet S1 reaches a position at which that leading edge is detected by the sheet sensor 27 (a detection position Pr). The time that passes from the timing at which the feed operation starts to the timing at which the sheet S1 reaches the sheet sensor 27 is called a “feed time”.

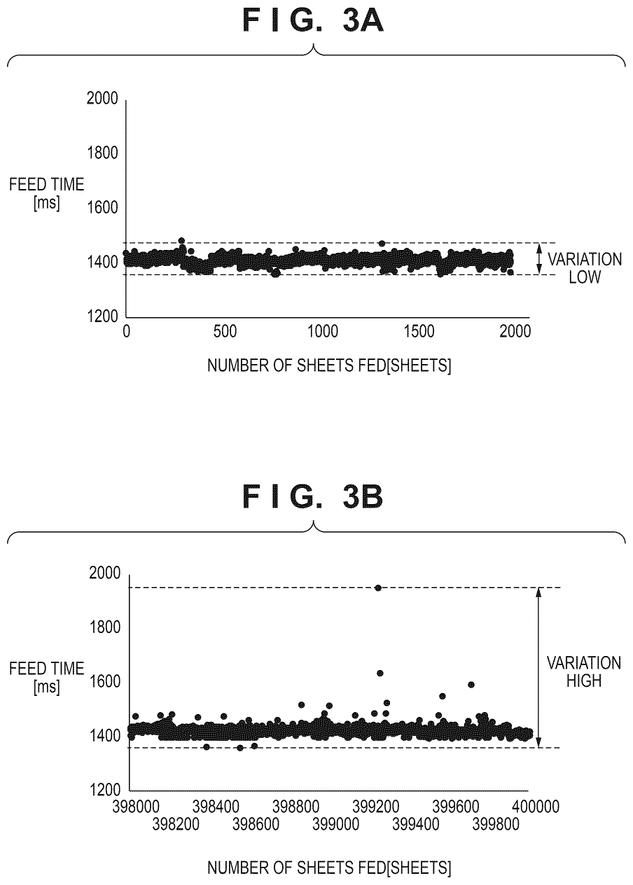

FIGS. 3A and 3B illustrate a plurality of feed times when the feed operations are repeatedly executed. The vertical axis represents the feed time. The horizontal axis represents the number of sheets fed. In particular, FIG. 3A illustrates the feed time for the first 2,000 feed operations when 400,000 feed operations are executed while the leading edge of the sheet S is at the conveyance start position Ps and the trailing edge of the sheet S is in contact with the trailing edge regulation plate 26. FIG. 3B illustrates the feed time for the last 2,000 feed operations of the 400,000 feed operations. As illustrated in FIG. 3A, variation in the feed time is lower when the number of feeds performed by the feed section 20 is low. However, as illustrated in FIG. 3B, variation in the feed time increases as the number of feeds performed by the feed section 20 increases. This is because as the number of feeds increases, the feed roller 22 becomes worn, and slippage between the feed roller 22 and the sheet S becomes more likely to occur.

### 3. Hardware

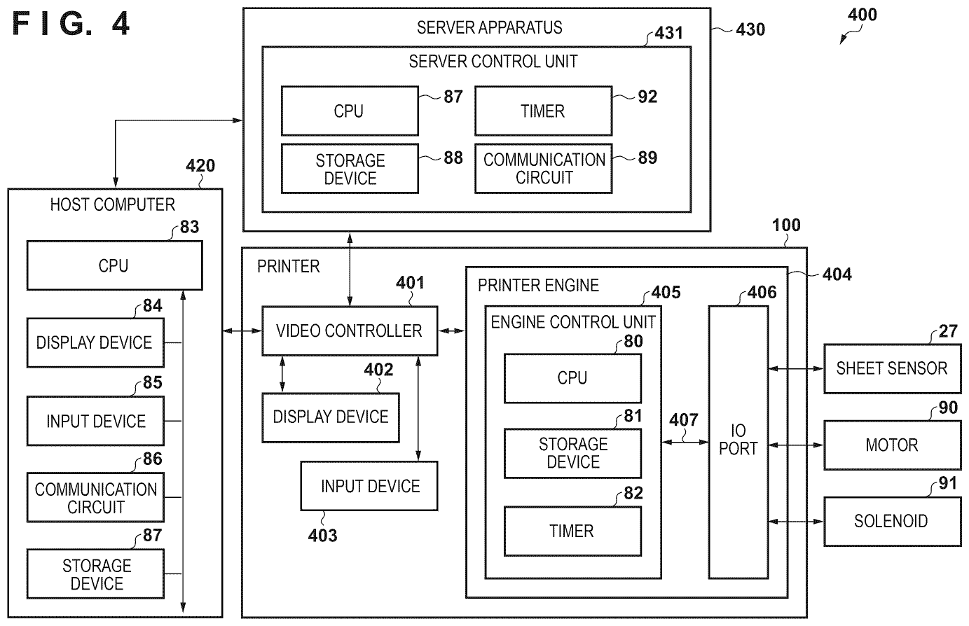

FIG. 4 is a diagram illustrating the hardware configurations of the printer 100, a server apparatus 430, and a host computer 420 included in an image forming system 400. The server apparatus 430 can communicate with at least one printer 100 and at least one host computer 420 over a network such as the Internet. The server apparatus 430 is a computer (information processing apparatus) responsible for the maintenance and management of at least one printer 100. The host computer 420 is a computer capable of communicating with the server apparatus 430 and the printer 100 over the network, and can be operated by a user, an administrator, or a maintenance person working for a dealer, for example.

The printer 100 includes a video controller 401, a display device 402, an input device 403, and a printer engine 404. The video controller 401 includes a communication circuit that receives image data from the host computer 420, an image scanner, or the like, and an image processing circuit that generates an image signal for the printer engine 404 by converting the image data. The video controller 401 can communicate with the server apparatus 430 through the communication circuit. The display device 402 is, for example, a liquid crystal display device or an organic electroluminescence (EL) display device that displays information to a user. The input device 403 includes switches, a touch sensor, and the like that accept the input of instructions from the user. The display device 402 and the input device 403 may be integrated to form an operation panel. The input device 403 may include a power switch, operation buttons, and the like. The video controller 401 sends image signals and print instructions to the printer engine 404.

The printer engine 404 includes an engine control unit 405, a system bus 407, and an IO port 406. The engine control unit 405 includes a CPU 80, a storage device 81, and a timer 82. “CPU” is an acronym for “central processing unit”. The storage device 81 includes a non-volatile memory (e.g., a read-only memory (ROM)) and a volatile memory (e.g., a random access memory (RAM)). A ROM region of the storage device 81 stores programs and various types of data. A RAM region is used as a work region. The timer 82 can include a real-time clock (RTC), a counter circuit that counts clock signals, or the like. The CPU 80 obtains the date/time using the timer 82, measures the length of time from one timing to another, and the like.

The CPU 80 implements various functions by executing programs. The CPU 80 receives detection results from the sheet sensor 27 through the system bus 407 and the IO port 406, and supplies drive signals to a motor 90 and a solenoid 91. Note that a drive circuit that generates drive current for the motor 90 may be provided between the IO port 406 and the motor 90. A drive circuit that generates drive current for the solenoid 91 may be provided between the IO port 406 and the solenoid 91. The motor 90 drives various rotating members, such as the conveyance roller 23 and the registration roller pair 25. Although one motor 90 is illustrated here, a plurality of motors may be provided. The solenoid 91 lowers the feed roller 22 to bring the feed roller 22 into contact with the sheet S1, and raises the feed roller 22 to separate the feed roller 22 from the sheet S1.

The server apparatus 430 includes a server control unit 431. The server control unit 431 is a control board including a CPU 87, a storage device 88, and a communication circuit 89. The CPU 87 executes programs stored in the storage device 88, and reads and writes various types of data. The CPU 87 includes a CPU core and a GPU core. “GPU” is an acronym for “graphics processing unit”. The storage device 88 can include a RAM, a ROM, a hard disk drive (HDD), and a solid-state drive (SSD). The CPU 87 may implement a virtual environment in accordance with a program, and the server may be implemented by the virtual environment. The server control unit 431 can pass information to the engine control unit 405 via the video controller 401. The server control unit 431 receives information from the host computer 420 over a network such as the Internet, sends information to the host computer 420, and the like. The communication circuit 89 includes circuitry for communicating with the printer 100 and the host computer 420. A timer 92 can include a real-time clock (RTC), a counter circuit, and the like.

The host computer 420 includes a CPU 83, a display device 84, an input device 85, and a communication circuit 86. The CPU 83 executes programs stored in a storage device 93 to implement various functions. The display device 84 is a liquid crystal display device or an organic EL display device that displays information to a user. The input device 85 includes a keyboard, a pointing device, and the like that accept inputs of instructions from the user. The communication circuit 86 is a circuit for wireless communication or wired communication with the printer 100 and the server apparatus 430. The storage device 93 can include a RAM, a ROM, an HDD, an SSD, or the like.

### 4. Control System

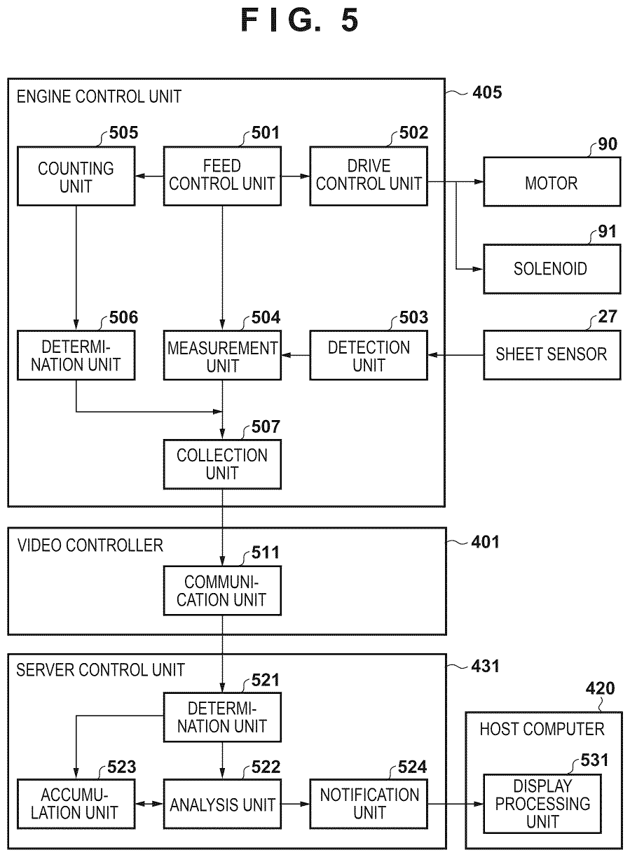

FIG. 5 illustrates functions of the engine control unit 405, the video controller 401, the server control unit 431, and the host computer 420. The functions of the engine control unit 405 are implemented by the CPU 80 in accordance with programs and data stored in the storage device 81. The functions of the video controller 401 are implemented in accordance with programs and data stored in a memory (not shown). The functions of the server control unit 431 are implemented by the CPU 87 on the basis of programs and data stored in the storage device 88. The functions of the host computer 420 are implemented by the CPU 83 on the basis of programs and data stored in a storage device 93. One or more of the plurality of functions implemented by the CPU 80 or the CPU 87 may be implemented by hardware modules such as application-specific integrated circuits (ASICs) or field-programmable gate arrays.

In the engine control unit 405, a feed control unit 501 controls the feeding of the sheets S. For example, when a print instruction is input by the user, the feed control unit 501 sends a feed instruction to a drive control unit 502. Upon receiving the feed instruction, the drive control unit 502 rotates the conveyance roller 23 and the separation roller 24 by starting the rotation of the motor 90. Furthermore, by controlling the solenoid 91, the drive control unit 502 causes the feed roller 22 to descend, which in turn causes the feed roller 22 to feed the sheet S. As a result, the one sheet S1 of the plurality of sheets S pushed up within the feed cassette 21 is separated and fed, and the sheet S1 is conveyed to the sheet sensor 27.

A detection unit 503 and a measurement unit 504 are functions that measure the feed time. The detection unit 503 monitors a detection signal output from the sheet sensor 27, and detects a timing at which the leading edge and the trailing edge of the sheet S pass. Using the timer 82, the measurement unit 504 measures the time from the timing at which the feed control unit 501 instructs the feed operation to be performed to the timing at which the leading edge of the sheet S is detected by the detection unit 503 (the feed time). The measurement unit 504 adds the date and time at which the feed time was measured (“feed date/time” hereinafter) to the feed time. The measurement unit 504 saves the feed time in the RAM region of the storage device 81 each time a sheet S is fed.

A counting unit 505 and a determination unit 506 are functions for determining or specifying the operation state of the feed section 20. When the feed operation is performed out by the feed control unit 501, the counting unit 505 adds 1 to a cumulative number of feeds stored in the non-volatile region of the storage device 81. Accordingly, the counting unit 505 counts the number of sheets S or pages on which an image has been formed by the printer 100. The counting unit 505 may also count the amount of the developing agent (toner) used to form images on the sheets S. Furthermore, the counting unit 505 may count the number of times a jam or a specific anomalous event has occurred. In this manner, the counting unit 505 obtains correlation information correlated with a consumption state of a consumable component.

The determination unit 506 determines the operation state of the feed section 20 by referring to the cumulative number of feeds stored in the storage device 81. Here, the “operation state” is a state indicating whether an operation history needs to be analyzed and whether the operation history needs to be accumulated. When the cumulative number of feeds is at least a first threshold and less than a second threshold, the determination unit 506 may determine that it is necessary to accumulate the operation history but that it is not necessary to analyze the operation history. When the cumulative number of feeds is at least the second threshold, the determination unit 506 may determine that it is necessary to accumulate the operation history and that it is also necessary to analyze the operation history. When the cumulative number of feeds is sent to the server apparatus 430, a determination unit 521 may perform such a determination instead of the determination unit 506. If the feed roller 22 is not worn, the replacement time (lifespan) of the feed roller 22 will not be reached soon. Such an operation state is called a “first state” (an “initial state”), and an accumulation unit 523 does not need to accumulate the operation history. On the other hand, when the feed roller 22 becomes worn and the replacement time (lifespan) of the feed roller 22 approaches, it is necessary for the accumulation unit 523 to start accumulating the operation history in preparation for identifying a more specific replacement time. Such an operation state is called a “second state” (an “accumulation-required state”). In the second state, the operation history is accumulated but is not analyzed. In the accumulation-required state, there are not enough data samples for analysis, and thus the accumulation-required state may be called an “analysis preparation state”. An operation state in which it is necessary to specify the replacement time by analyzing the actual operation history will be called a “third state” (an “accumulation analysis-required state”). In the third state, the operation history is continuously accumulated and is analyzed.

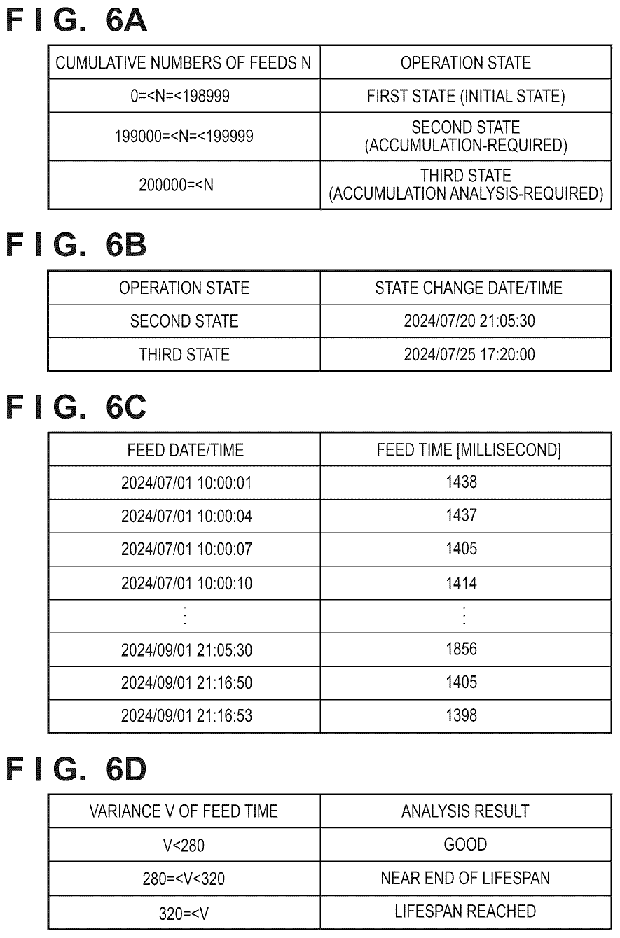

FIG. 6A is a table illustrating a relationship between the cumulative number of feeds and the operation state. As one example, in the first state, the cumulative number of feeds is from 0 to 198,999. In the second state, the cumulative number of feeds is from 199,000 to 199,999. This means that 1000 pieces of operation history data are required for analysis. Note that 199,000 is used as a threshold for detecting that the operation state has transitioned from the first state to the second state. In the third state, the number is 200,000 or more. 200,000 may be used as a threshold for detecting that the operation state has transitioned from the second state to the third state. These specific numbers are merely examples, however. When the feed roller 22 is replaced, the cumulative number of feeds is reset to 0.

A collection unit 507 is a function for collecting the operation history of a replacement component (e.g., the feed section 20). The operation history may be called “collected data”, “operation data”, or “historical data”. The collection unit 507 generates an operation history including the date/time when the operation state of the feed section 20 changed, and sends the operation history to a communication unit 511 provided in the video controller 401. The operation history can include a plurality of fields. A state field holds information indicating the operation state. A date/time field includes information indicating the date/time at which the operation state changed. When the operation state is the second state, the collection unit 507 also sends instruction information for instructing the operation history to be accumulated to the communication unit 511. When the operation state is the third state, the collection unit 507 sends instruction information, which is information instructing the server control unit 431 to accumulate and analyze the operation history, to the communication unit 511. Note that if the operation state has not reached the second state, the date/time field for the state change included in the operation history may be empty. In other words, the date/time field being empty may indirectly suggest that there are no instructions for accumulation and analysis. In this manner, the date/time field and the instruction information are sent to the server apparatus 430 as data associated with the printer 100. The date/time field may be interpreted indirectly as data indicating the usage status or the lifespan of the replacement components (consumable components) constituting the printer 100. In accordance with the result of the determination by the determination unit 506, the collection unit 507 skips sending the operation history and data (the instruction information), sends the operation history and data (the accumulation instruction), sends the operation history and data (the accumulation instruction and the analysis instruction), or the like

FIG. 6B illustrates an example of the operation history pertaining to the operation state. The operation history in the second state and the operation history in the third state each has a date/time field for the state change. Date/time information is stored in the date/time field. Although the operation history in the first state is not illustrated, the date/time field is empty in that operation history.

The collection unit 507 further sends, as the operation history of the feed section 20, the feed time measured by the measurement unit 504 and the date/time at which the feed time was measured (the feed date/time) to the communication unit 511. FIG. 6C illustrates an example of the operation history pertaining to the feed time. The feed time is an example of conveyance information pertaining to the conveyance time of the sheet S.

The communication unit 511 transfers the state change date/time, the feed date/time, and the feed time to the server control unit 431.

The server control unit 431 includes the determination unit 521, which determines whether it is necessary to analyze the operation history of the feed section 20. The determination unit 521 determines whether the date/time at which the operation state changed from the first state to the second state is included in the operation history received from the printer 100. If the date/time is included, the determination unit 521 interprets this as an accumulation instruction, and passes the operation history to the accumulation unit 523. The accumulation unit 523 accumulates the operation history in the storage device 88 in accordance with the result of the determination by the determination unit 521. As illustrated in FIG. 6B, if “2024/7/20 21:5:30” is recorded in the date/time field, the accumulation unit 523 accumulates an operation history having a date/time from “2024/7/20 21:5:30” and on in the storage device 88. If the date/time field is empty, the determination unit 521 determines that there is no accumulation instruction or analysis instruction, and discards the operation history received from the printer 100. If the date/time at which the operation state changed from the second state to the third state has been recorded in the operation history, the determination unit 521 determines that accumulation and analysis have been instructed. In this case, the determination unit 521 instructs the accumulation unit 523 to accumulate the operation history, and instructs an analysis unit 522 to analyze the operation history.

Upon being instructed to analyze the operation history by the determination unit 521, the analysis unit 522 analyzes the operation history stored in the storage device 88 (e.g., the feed time). For example, the analysis unit 522 calculates a variance V of the feed times measured for the most recent X number of sheets S. X is 1,000, for example. As illustrated in FIGS. 3A and 3B, the variance V of the feed time increases as the amount of wear of the feed roller 22 increases. Accordingly, the analysis unit 522 can estimate a state of wear of the feed section 20 on the basis of the variance V.

FIG. 6D illustrates a relationship between the variance V and an analysis result. If the variance V is less than a first threshold (e.g., 280), the analysis unit 522 outputs “good (no replacement required)” as the analysis result. If the variance V is at least the first threshold (e.g., 280) but less than a second threshold, the analysis unit 522 outputs “near end of lifespan (replacement preparation required)” as the analysis result. If the variance V is at least the second threshold (e.g., 320), the analysis unit 522 outputs “lifespan reached (replacement required)” as the analysis result. The analysis unit 522 saves the analysis result in the storage device 88 in association with the feed date/time.

If the analysis result is “lifespan reached”, a notification unit 524 notifies the host computer 420 of a message indicating response details over the network. A display processing unit 531 of the host computer 420 displays the response details (e.g., information indicating that it is necessary to replace the feed roller 22) on the display device 84.

### 5. Flowchart

### 5-1. Processing Executed by Printer

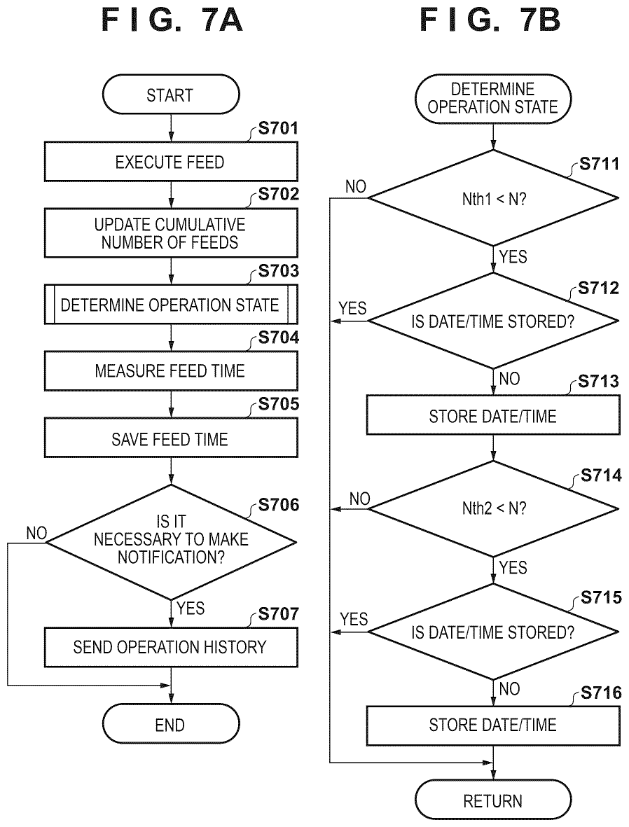

FIG. 7A illustrates a control method implemented by the CPU 80 in accordance with a control program. The CPU 80 executes the following processing when a print instruction is input.

In step S701, the CPU 80 (the feed control unit 501 and the drive control unit 502) starts the motor 90, and controls the motor 90 and the solenoid 91 to feed a sheet S.

In step S702, the CPU 80 (the counting unit 505) updates the cumulative number of feeds N. In other words, 1 is added to the cumulative number of feeds N.

In step S703, the CPU 80 (the determination unit 506) determines the operation state of the feed section 20. The process for determining the operation state will be described later with reference to FIG. 7B.

In step S704, the CPU 80 (the detection unit 503 and the measurement unit 504) measures the feed time of the sheet S using the sheet sensor 27. In step S705, the CPU 80 (the collection unit 507) saves the feed time in the RAM region of the storage device 81. As described above, the feed time and the feed date/time are saved in the storage device 81.

In step S706, the CPU 80 (the determination unit 506) determines whether it is necessary to make a notification of the operation history on the basis of a notification condition for the operation history. The notification condition is, for example, that the cumulative number of feeds N exceeds a first threshold Nth1. In other words, the notification condition is that the operation state has changed to the second state or the third state. If the notification condition has been met, the CPU 80 moves the sequence from step S706 to step S707. If the notification condition has not been met, the CPU 80 skips step S707. Note that the notification condition may be that the operation state has changed, every predetermined number of prints, every set length of time (e.g., once a day), or the like.

In step S707, the CPU 80 (the collection unit 507) sends the operation history to the server apparatus 430 through the video controller 401. Here, the operation history includes, for example, information indicating the operation state of the feed section 20, the feed date/time, and the feed time.

FIG. 7B illustrates the processing for determining the operation state in detail. In step S711, the CPU 80 (the determination unit 506) determines whether the cumulative number of feeds N exceeds the first threshold Nth1. If the cumulative number of feeds N does not exceed the first threshold Nth1, the CPU 80 moves the sequence from step S711 to step S704. However, if the cumulative number of feeds N exceeds the first threshold Nth1, the CPU 80 moves the sequence from step S711 to step S712.

In step S712, the CPU 80 (the determination unit 506) determines whether the date/time at which the operation state changed from the first state to the second state is stored in the non-volatile region of the storage device 81. If the date/time is stored in the storage device 81, the CPU 80 moves the sequence from step S712 to step S704. However, if the date/time is not stored in the storage device 81, the CPU 80 moves the sequence from step S712 to step S713.

In step S713, the CPU 80 (the collection unit 507) stores the date/time at which the operation state changed from the first state to the second state in the non-volatile region of the storage device 81.

In step S714, the CPU 80 (the determination unit 506) determines whether the cumulative number of feeds N exceeds a second threshold Nth2. If the cumulative number of feeds N does not exceed the second threshold Nth2, the CPU 80 moves the sequence from step S714 to step S704. However, if the cumulative number of feeds N exceeds the second threshold Nth2, the CPU 80 moves the sequence from step S714 to step S715.

In step S715, the CPU 80 (the determination unit 506) determines whether the date/time at which the operation state changed from the second state to the third state is stored in the non-volatile region of the storage device 81. If the date/time is stored in the storage device 81, the CPU 80 moves the sequence from step S715 to step S704. However, if the date/time is not stored in the storage device 81, the CPU 80 moves the sequence from step S715 to step S716.

In step S716, the CPU 80 (the collection unit 507) stores the date/time at which the operation state changed from the second state to the third state in the non-volatile region of the storage device 81.

### 5-2. Processing Executed by Server Apparatus

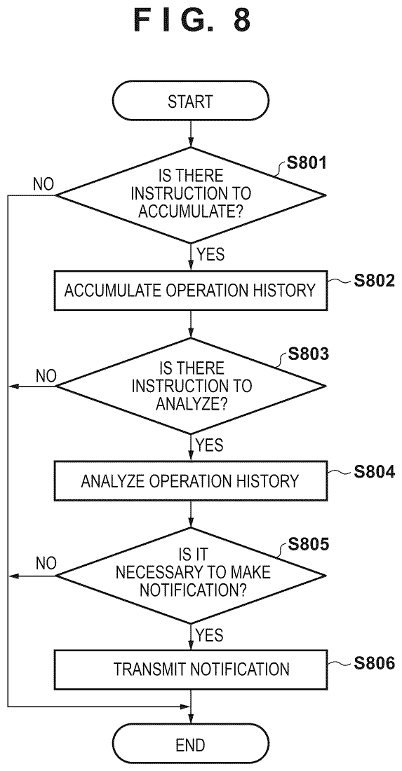

FIG. 8 illustrates a control method executed by the CPU 87 of the server apparatus 430. In step S801, the CPU 87 (the determination unit 521) determines whether an accumulation instruction is present in the operation history received from the printer 100. For example, if the date/time field in the operation history includes a date/time (the date/time at which the operation state changed from the first state to the second state), the CPU 87 moves the sequence from step S801 to step S802. If no date/time is included, the CPU 87 skips the processing from steps S802 to S806.

In step S802, the CPU 87 (the accumulation unit 523) accumulates the operation history in the storage device 88. As a result, the operation history obtained from the date/time at which the operation state changed from the first state to the second state and on is accumulated in the storage device 88.

In step S803, the CPU 87 (the determination unit 521) determines whether an analysis instruction is present in the operation history received from the printer 100. For example, if the date/time field in the operation history includes the date/time at which the operation state changed from the second state to the third state, the CPU 87 moves the sequence from step S803 to step S804. If no date/time is included, the CPU 87 skips the processing from steps S804 to S806.

In step S804, the CPU 87 (the analysis unit 522) adds the operation history to the storage device 88 and analyzes the operation history accumulated in the storage device 88. The analysis unit 522 calculates the variance V from the feed time included in the operation history corresponding to the most recent X number of sheets, and determines the analysis result on the basis of the variance V.

In step S805, the CPU 87 (the analysis unit 522) determines whether it is necessary to make a notification for the analysis result, on the basis of the analysis result. If no notification is necessary, the CPU 87 skips step S806. If a notification is necessary, the CPU 87 moves the sequence from step S805 to step S806.

In step S806, the CPU 87 (the notification unit 524) transmits a notification of the analysis result (e.g., including the response details) to the host computer 420. For example, if the analysis result is “lifespan reached”, a notification of “the feed roller should be replaced” is made as the response details. Upon receiving the notification, the CPU 83 (the display processing unit 531) of the host computer 420 displays the notification on the display device 84.

According to the first embodiment, the printer 100 determines the need for analysis on the basis of the data pertaining to the state or type of the printer 100 (a primary determination), which reduces the number of times the analysis is performed by the server apparatus 430, and also reduces the operation cost of the image forming system 400. Furthermore, if it is not necessary to accumulate the operation history, the server apparatus 430 discards the operation history. This reduces the storage capacity required by the storage device 88 of the server apparatus 430, and also reduces the operation cost of the image forming system 400. The data pertaining to the state or type of the printer 100 may be instruction information instructing the analysis to be performed, on the basis of the data indicating the state or type of the printer 100.

Although only a single feed section 20 is present in FIG. 1, a plurality of feed sections 20 may be present. In this case, the counting unit 505 may count the cumulative number of feeds N for each feed section 20, or may calculate the total of the cumulative numbers of feeds N of the plurality of feed sections 20. In the former case, the replacement times for the replacement components present in each feed section 20 can be accurately determined on the basis of individual analyses. In the latter case, the replacement times for replacement components common to the plurality of feed sections 20 (e.g., the registration roller pair 25, the intermediate transfer member 11, and the fixing apparatus 30) can be accurately determined on the basis of analyses using aggregate values. In this manner, in the latter case, the replacement time of the replacement component involved in both a sheet S fed from a first feed section 20 and a sheet S fed from a second feed section 20 can be specified.

Although the first embodiment describes the feed section 20 as the replacement component to be analyzed, this is merely one example. The fixing apparatus 30 or the intermediate transfer member 11 may be the replacement component.

A plurality of determination methods may be present. For example, the necessity of accumulating and analyzing the operation history may be determined on the basis of the frequency of conveyance anomalies such as the early arrival, delay, or jams of the sheet S, according to the feed time. The necessity of accumulating and analyzing the operation history may be determined on the basis of the frequency of occurrence of other anomalous events collected in the printer 100 (e.g., jams or fixing failures in the fixing apparatus 30, jams or transfer failures at the intermediate transfer member 11, and the like). The determination unit 521 obtains a determination result through each of the plurality of determination methods. At least one of the plurality of determination results may indicate the necessity of accumulation or analysis. In this case, the determination unit 521 determines that accumulation or analysis is necessary. If all of the determination results indicate that accumulation and analysis are not necessary, the determination unit 521 determines that accumulation and analysis of the operation history is not necessary. Alternatively, the determination unit 521 may determine that accumulation or analysis is necessary when N or more of M determination results indicate the necessity of accumulation or analysis. Here, M is an integer of 2 or more, and N is a positive integer of M or less.

Furthermore, the determination unit 521 and the analysis unit 522 may be provided for each replacement component be analyzed. For example, the determination unit 521 and the analysis unit 522 may be provided for the fixing apparatus 30, and the determination unit 521 and the analysis unit 522 may also be provided for the intermediate transfer member 11. In this case, the necessity of accumulating and analyzing the operation history is determined for each replacement component.

In the first embodiment, the notification unit 524 sends the response details to the host computer 420, but this is merely one example. The notification unit 524 may notify the printer 100 of the response details. Upon receiving the response details, the video controller 401 may display the response details on the display device 402.

### Second Embodiment

In a second embodiment, a warranty period set in the printer 100 is used as the data pertaining to the state or type of the printer 100. In the second embodiment, the operation history is accumulated and analyzed if the warranty period set in the printer 100 has not yet expired, but the accumulation and analysis of the operation history is skipped if the warranty period has expired. Here, the “warranty period” is a period during which the manufacturer that manufactured the printer 100 or the dealer that sold the printer 100 is required to provide user support at no charge or for a fee. The warranty period of the printer 100 may be associated with the identification information of the printer 100 and managed by the server apparatus 430. In this case, the identification information of the printer 100 is included in the data collected by the collection unit 507. The server apparatus 430 specifies the warranty period on the basis of the identification information, and determines whether accumulation and analysis are necessary on the basis of the warranty period. The warranty period may be replaced with an expiration date of the printer 100.

In the second embodiment, the functions of the engine control unit 405 described in the first embodiment may be changed. For example, the engine control unit 405 need not include the counting unit 505 and the determination unit 506. In this case, the identification information of the printer 100 is included in the data collected by the collection unit 507 (e.g., the operation history). The details of the determination by the determination unit 521 of the server control unit 431 are changed as well. In the second embodiment, descriptions of details that are the same as in the first embodiment will be omitted. Items that are the same or similar will be given the same reference signs, and descriptions thereof will be omitted.

### 1. Functions in Second Embodiment

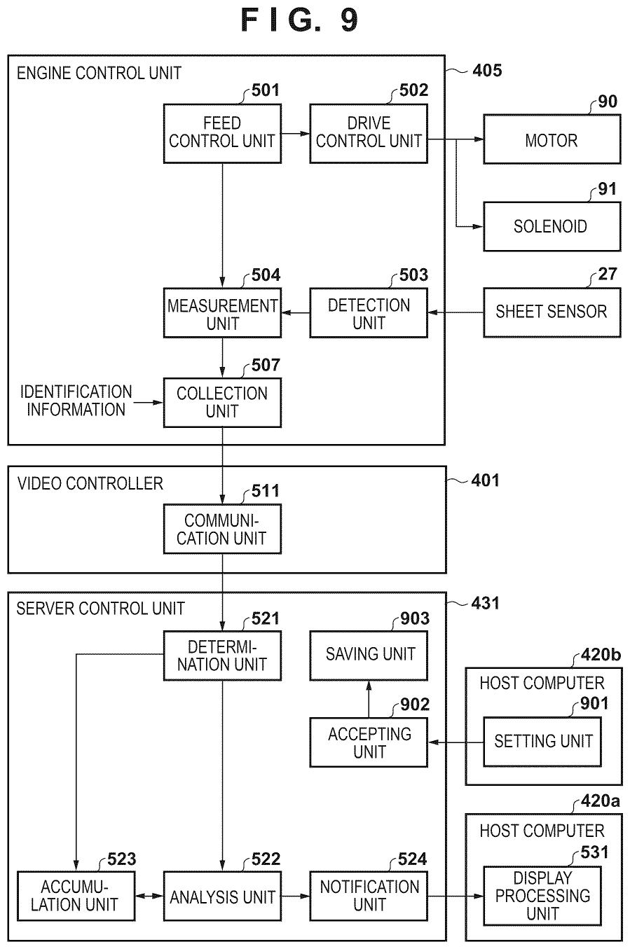

FIG. 9 illustrates functions of the engine control unit 405, the video controller 401, the server control unit 431, and host computers 420a and 420b. Although the host computers 420a and 420b are illustrated as separate, the host computers 420a and 420b may be a single computer. The hardware of the host computers 420a and 420b may be the same as the hardware of the host computer 420 illustrated in FIG. 4.

The collection unit 507 of the engine control unit 405 collects the operation history, such as the feed time and the feed date/time, and obtains the identification information of the printer 100 stored in the ROM region or the RAM region of the storage device 81. The collection unit 507 sends the operation history and the identification information of the printer 100 to the server apparatus 430 through the communication unit 511. The operation history and the identification information of the printer 100 may be sent together or individually. In the former case, an ID field may be provided in the operation history, and the identification information of the printer 100 may be stored in the ID field. “ID” is an acronym for “identifier”. The identification information of the printer 100 may be stored by the video controller 401. In this case, the video controller 401 notifies the engine control unit 405 of the identification information, and the engine control unit 405 stores the identification information in the storage device 81.

The determination unit 521 of the server control unit 431 refers to the warranty period, which is set in advance for each printer 100, to determine whether the accumulation processing can be executed by the accumulation unit 523 and whether the analysis processing can be executed by the analysis unit 522. If the warranty period has not expired, the determination unit 521 determines that the accumulation processing can be executed, and transfers an accumulation instruction and the operation history to the accumulation unit 523. The accumulation unit 523 stores the operation history in the storage device 81 in accordance with the accumulation instruction from the determination unit 521. If the warranty period has not expired, the determination unit 521 determines that the analysis processing can be executed, and sends an analysis instruction to the analysis unit 522. If the amount of operation history required for the analysis is present in the storage device 81, the analysis unit 522 executes the analysis processing in accordance with the analysis instruction. The notification unit 524 sends the analysis result (the response details) to the host computer 420a. The display processing unit 531 displays the analysis result (the response details) on the display device 84.

The host computer 420b includes a setting unit 901 that sets an execution condition (e.g., the warranty period) for accumulating and analyzing the operation history. The host computer 420b may be operated by a user of the image forming system 400, for example. The user of the image forming system 400 is not the user of the printer 100, but another user (e.g., an administrator or a seller) who uses the image forming system 400. The other user provides support for the user to use the printer 100 smoothly (maintenance for the printer 100 and the like). To distinguish the user of the printer 100 from the other user of the image forming system 400, the former may be called a “printer user”, and the latter may be called a “system user”. The system user operates the input device 85 of the host computer 420b and starts the setting unit 901. The setting unit 901 accesses an accepting unit 902 of the server control unit 431 through the communication circuit 86, receives display data of a setting UI, and displays the setting UI on the display device 84. “UI” is an acronym for “user interface”.

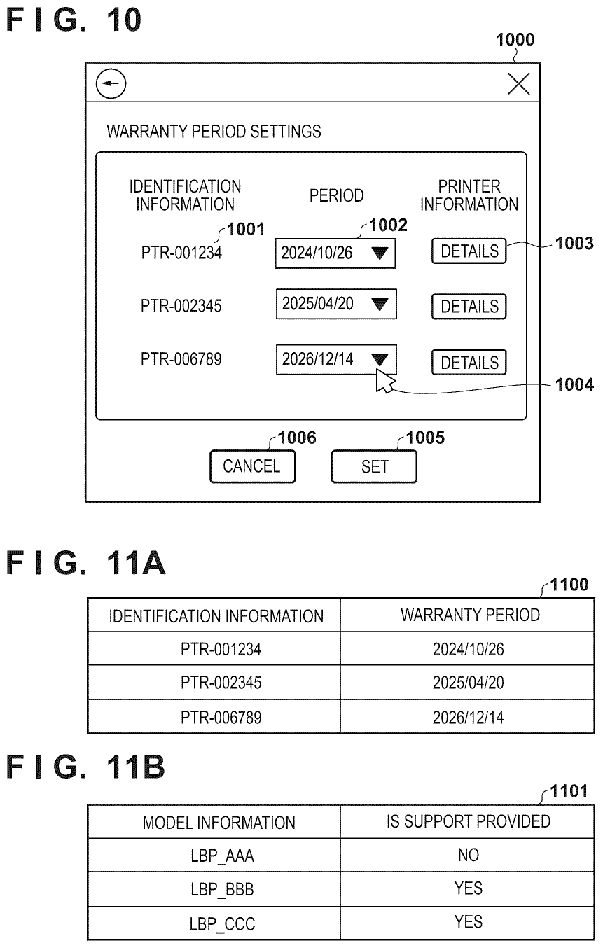

FIG. 10 is a diagram illustrating a setting UI 1000. An identification information display unit 1001 displays the identification information of the printer 100. A warranty period input unit 1002 accepts the input of the warranty period set in the printer 100. A details button 1003 is a button for instructing detailed information about the corresponding printer 100 to be displayed. The detailed information may include identification information of the printer user (e.g., a name or a user ID), an installation location (e.g., an address), and the like. A pointer 1004 is operated through the input device 85, and is used to specify an operation target, press buttons, and the like. A set button 1005 is a button for instructing the server apparatus 430 to apply the settings input through the setting UI 1000. A cancel button 1006 is a button for discarding settings input through the setting UI 1000. When the set button 1005 is pressed, the setting unit 901 sends the identification information of the printer 100 and the corresponding warranty period to the accepting unit 902.

The accepting unit 902 sends an instruction for saving the identification information of the printer 100 and the corresponding warranty period to a saving unit 903. The saving unit 903 saves the identification information in the storage device 81 in association with the warranty period in accordance with the saving instruction. FIG. 11A illustrates a database 1100 saved in the storage device 81. The database 1100 stores the identification information and the warranty period in association with each other. The determination unit 521 can read out the warranty period corresponding to the identification information received from the printer 100 by referring to the database 1100. For example, the determination unit 521 determines whether the warranty period of the printer 100 has expired by comparing the date when the data (e.g., the operation history) was received from the printer 100 with the last day of the warranty period. In other words, the determination unit 521 determines whether support for the printer 100 is active or inactive.

### 2. Flowchart

### 2-1. Control Method of Printer 100

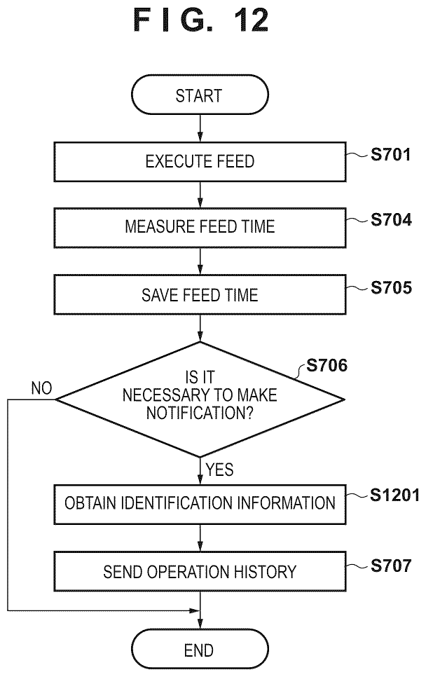

FIG. 12 illustrates a control method executed by the CPU 80 of the engine control unit 405 in accordance with the control program. Of the processing illustrated in FIG. 12, processing that is the same as that illustrated in FIG. 7 will be given the same reference signs. FIG. 12 differs from FIG. 7 in that steps S702 and S703 have been omitted, and step S1201 has been added between steps S706 and S707. If a notification of the operation history is required, the CPU 80 moves the sequence from step S706 to step S1201.

In step S1201, the CPU 80 (the collection unit 507) obtains the identification information of the printer 100 from the storage device 81. In step S707, the CPU 80 (the collection unit 507) collects the operation history (the feed date/time and the feed time), and sends the identification information and the operation history to the server apparatus 430.

### 2. Control Method of Server Apparatus 430

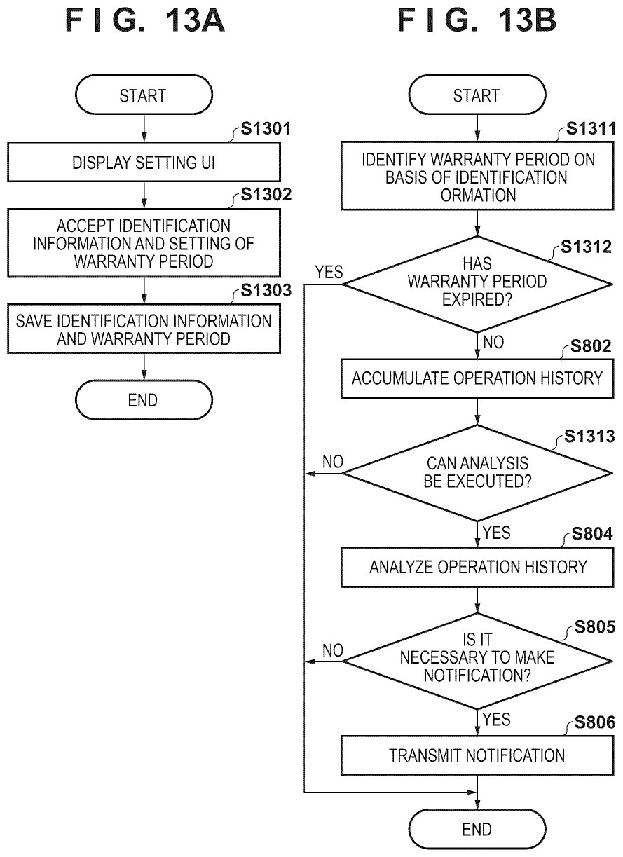

FIG. 13A illustrates a method for setting the warranty period, executed by the CPU 87 of the server apparatus 430. The CPU 87 executes the following processing upon receiving a request for the setting UI 1000 from the host computer 420b.

In step S1301, the CPU 87 (the accepting unit 902) displays the setting UI 1000 in the host computer 420b by sending the display data of the setting UI 1000 in response to the request received from the host computer 420b.

In step S1302, the CPU 87 (the accepting unit 902) accepts the identification information of the printer 100 and the setting of the warranty period from the host computer 420b. The accepting unit 902 sends a saving instruction, the identification information of the printer 100, and the warranty period to the saving unit 903.

In step S1303, the CPU 87 (the saving unit 903) saves the identification information of the printer 100 and the warranty period in the database 1100. Through this, the identification information of the printer 100 is associated with the warranty period in the database 1100.

FIG. 13B illustrates a control method (accumulation processing and analysis processing) executed by the CPU 87 of the server apparatus 430. Comparing FIG. 13B with FIG. 8, it can be seen that step S801 has been replaced with steps S1311 and S1312. In addition, step S803 has been replaced with step S1313.

In step S1311, the CPU 87 (the determination unit 521) refers to the database 1100 on the basis of the identification information of the printer 100 included in the data received from the printer 100, and specifies the warranty period.

In step S1312, the CPU 87 (the determination unit 521) determines whether the warranty period has expired. If the warranty period has expired, the determination unit 521 discards the operation history, and skips the accumulation and analysis of the operation history. However, if the warranty period has not expired, the CPU 87 moves the sequence from step S1312 to step S802. In step S802, the operation history is accumulated in the storage device 88.

In step S1313, the CPU 87 (the determination unit 521) determines whether the analysis of the operation history can be executed. For example, whether the amount of the operation history accumulated in the storage device 88 is a sufficient amount (e.g., operation history for 1,000 sheets S) is determined. If the analysis of the operation history can be executed, the CPU 87 moves the sequence from step S1313 to step S804 and analyzes the operation history. If the analysis of the operation history cannot be executed, the CPU 87 skips steps S804 to S806.

According to the second embodiment, the operation history is accumulated and analyzed for the printer 100, among a plurality of printers 100, that meets a specific condition. This reduces the number of times the analysis is executed by the server apparatus 430, and also reduces the operation cost of the image forming system 400. Furthermore, if it is not necessary to accumulate the operation history, the server apparatus 430 discards the operation history. This makes it possible to reduce the storage capacity required by the storage device 88 of the server apparatus 430, and also reduces the operation cost of the image forming system 400.

In the second embodiment, the need for accumulation and analysis is determined on the basis of the warranty period of the printer 100, but this is merely one example. The execution frequency (execution interval) of the accumulation and analysis may be used instead of the warranty period. For example, the execution frequency may be set for the identification information of the printer 100 through the setting UI 1000. The execution frequency may be information indicating a time interval at which the notification of the analysis result is made (e.g., a number of days, a number of weeks, or a number of months), for example.

Although the second embodiment describes the setting of the warranty period or execution frequency being made by the system user, this is merely one example. The printer user may make the settings instead.

The notification unit 524 sends the response details to the host computer 420a of the printer user, but this is merely one example. The notification unit 524 may send the response details to the host computer 420b of the system user. The notification unit 524 may notify the printer 100 of the response details.

### Third Embodiment

Various models of the printer 100 may be present in accordance with a sales strategy. For example, a model with only basic support from the seller may be offered for users who prioritize the purchase cost of the printer 100. In addition, a model with advanced support from the seller may be offered for users who prioritize ease of use of the printer 100. Accordingly, whether the operation history can be accumulated and analyzed can be determined on the basis of information indicating the model, which is an example of the data pertaining to the state or type of the printer 100.

Accordingly, in the third embodiment, the collection unit 507 sends model information of the printer 100 to the server apparatus 430. The determination unit 521 of the server apparatus 430 identifies the details of supplemental support provided for the printer 100 (e.g., whether a maintenance service is available) on the basis of the model information, and accumulates and analyzes the operation history in accordance with the support details. The model information is identification information for distinguishing the product model. For example, the model information may be unique information corresponding to a product model number of the printer 100 on a one-to-one basis. In the third embodiment, a model supported by the seller and a model not supported by the seller are distinguished according to the model number. With a supported model, the seller of the printer 100 provides support so that the printer user can use the printer 100 unhindered. For example, an indication of an anomaly in an image may be detected on the basis of the operation history, and the consumable component that may have caused the anomaly may be replaced.

### 1. Functions of Image Forming System

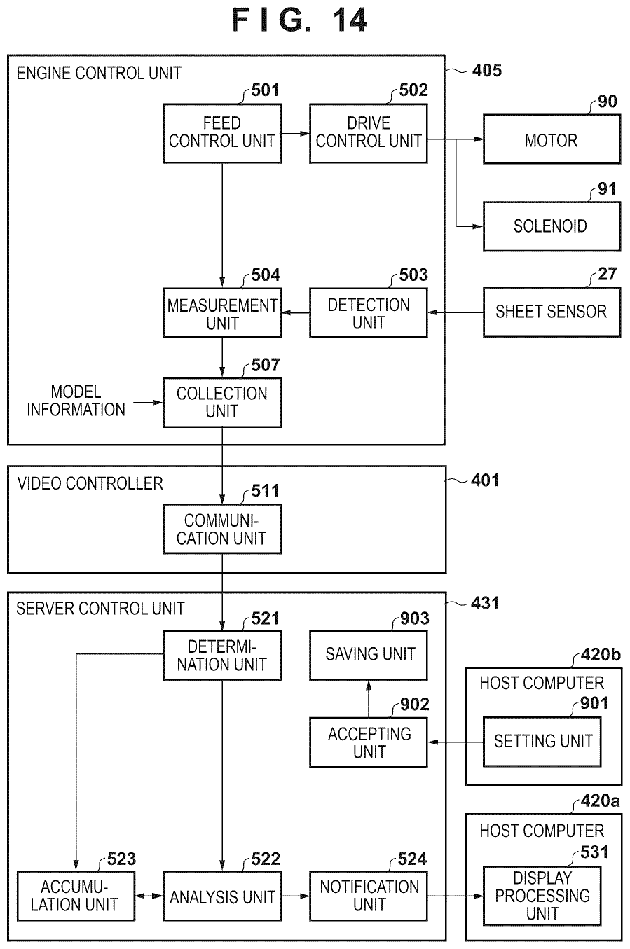

FIG. 14 illustrates functions of the engine control unit 405, the video controller 401, the server control unit 431, and host computers 420a and 420b. Functions that have already been described will be given the same reference signs, and descriptions thereof will be omitted.

The collection unit 507 of the engine control unit 405 sends the model information of the printer 100 to the server apparatus 430 in addition to the operation history. The engine control unit 405 may be notified of the model information by the video controller 401 and stored in the RAM region of the storage device 81 of the engine control unit 405. Alternatively, the model information may be held in the ROM region of the storage device 81.

The determination unit 521 of the server control unit 431 uses the model information to determine whether the accumulation processing by the accumulation unit 523 and the analysis processing by the analysis unit 522 can be executed. For example, the determination unit 521 reads out the support details associated with the received model information from the storage device 88, and determines whether support is provided by the seller on the basis of the support details.

The setting unit 901 sets the support details for each piece of model information and sends the support details to the accepting unit 902. The accepting unit 902 sends the saving instruction, the model information, and the support details to the saving unit 903. The saving unit 903 saves the model information and the support details in association with each other in the storage device 88.

FIG. 11B illustrates an example of a database 1101 holding support details for each piece of model information in the storage device 88. In this example, information indicating whether support is provided (maintenance information indicating whether a maintenance service is provided) is stored for each piece of model information. For example, “yes” for support indicates that the accumulation processing by the accumulation unit 523 and the analysis processing by the analysis unit 522 are required. “No” for support indicates that the accumulation processing by the accumulation unit 523 and the analysis processing by the analysis unit 522 are not required.

### 2. Flowchart

### 2-1. Control Method of Printer 100

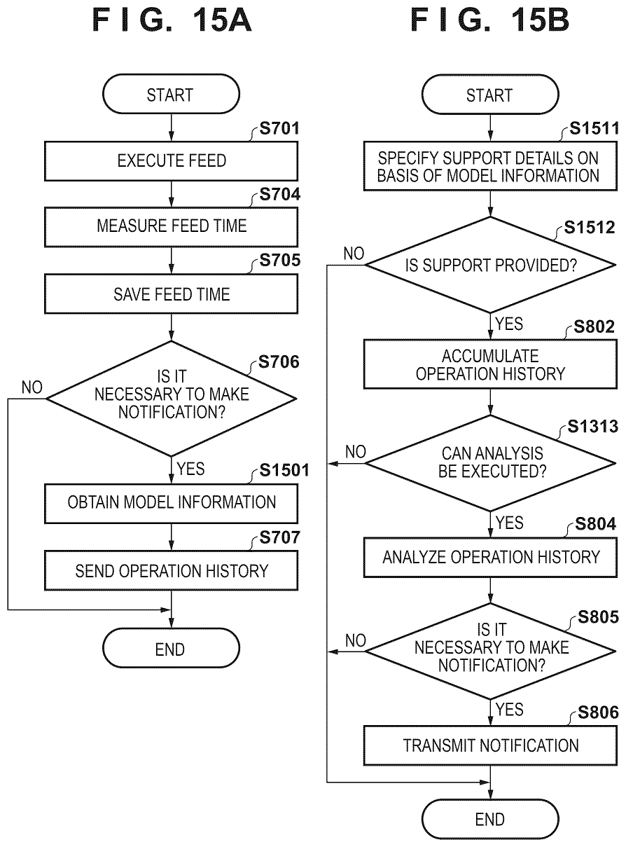

FIG. 15A illustrates a control method executed by the CPU 80 of the engine control unit 405 in accordance with the control program. Of the processing illustrated in FIG. 15A, processing that is the same as that illustrated in FIG. 7 will be given the same reference signs. FIG. 15A differs from FIG. 7 in that steps S702 and S703 have been omitted, and step S1501 has been added between steps S706 and S707. If a notification of the operation history is required, the CPU 80 moves the sequence from step S706 to step S1501.

In step S1501, the CPU 80 (the collection unit 507) obtains the model information of the printer 100 from the storage device 81. In step S707, the CPU 80 (the collection unit 507) collects the operation history (the feed date/time and the feed time), and sends the model information and the operation history to the server apparatus 430.

### 2-2. Control Method of Server Apparatus 430

FIG. 15B illustrates a control method (accumulation processing and analysis processing) executed by the CPU 87 of the server apparatus 430. Comparing FIG. 15B with FIG. 13, steps S1311 and S1312 have been replaced with steps S1511 and S1512.

In step S1511, the CPU 87 (the determination unit 521) refers to the database 1101 on the basis of the model information of the printer 100 included in the data received from the printer 100, and specifies the support details.

In step S1512, the CPU 87 (the determination unit 521) determines whether support is provided. If support is not provided, the determination unit 521 discards the operation history, and skips the accumulation and analysis of the operation history. If support is provided, the CPU 87 moves the sequence from step S1512 to step S802. In step S802, the operation history is accumulated in the storage device 88. The subsequent processing is as described in the second embodiment.

According to the third embodiment, the operation history is accumulated and analyzed for the printer 100 that is a supported model, among a plurality of printers 100. This reduces the number of times the analysis is executed by the server apparatus 430, and also reduces the operation cost of the image forming system 400. Furthermore, if it is not necessary to accumulate the operation history, the server apparatus 430 discards the operation history. This reduces the storage capacity required by the storage device 88 of the server apparatus 430, and also reduces the operation cost of the image forming system 400.

In the third embodiment, a model in which both accumulation and analysis are executed, and a model in which neither accumulation nor analysis are executed, are illustrated. However, three or more models may be present. For example, there may be a model in which the operation history is accumulated but the analysis is not executed. The operation history collected from such a model may be used as big data. For example, big data may be used to improve the printer 100, or may be used for market analysis.

A priority may be used in determining the accumulation and analysis. For example, the identification information (the warranty period) and the model information (the support details) may be present as information accompanying the operation history. Furthermore, the priority of the model information may be higher than the priority of the identification information. In this case, the model information is analyzed prior to the identification information. When it is determined that it is necessary to accumulate and analyze the operation history on the basis of the model information, the warranty period is further determined on the basis of the identification information. If on the basis of the model information it is determined that the operation history need not be accumulated or analyzed, the determination of the warranty period based on the identification information is skipped. This reduces the time required for the determination processing, eliminates unnecessary executions of the determination processing, and reduces the operation cost. Conversely, the priority of the identification information may be higher than the priority of the model information. In this case, although the model information indicates that accumulation and analysis are not necessary, if the warranty period associated with the identification information is valid, the accumulation and analysis are determined to be necessary. For example, if an attribute of the customer, indicated by the identification information, indicates that the customer is a regular customer, the accumulation and analysis may be determined to be necessary regardless of the model information.

The collected data may include one or more pieces of information that can be used to determine whether to execute the analysis (e.g., an accumulation instruction, an analysis instruction, the identification information, or the model information). In this case, the determination unit 521 may specify any information in accordance with a priority set in advance for the plurality of pieces of information, and determine whether to execute the analysis on the basis of the specified information. For example, the determination unit 521 determines whether to execute accumulation and analysis on the basis of the information having the highest priority. If it is determined that accumulation and analysis are necessary on the basis of the information having the highest priority, the determination based on other information with lower priority is unnecessary, which reduces operation costs. If it is determined that accumulation and analysis are not necessary on the basis of information having a given priority, the determination unit 521 executes determination processing based on the information of the next-highest priority. Note that setting information indicating on the basis of which of the plurality of pieces of information the determination processing is to be executed may be saved in the saving unit 903 by the setting unit 901 in advance. In this case, the determination unit 521 executes the determination processing using the information indicated by the setting information among the plurality of pieces of information, and skips determination processing that uses the information not indicated by the setting information. The operation cost may be reduced as a result.

The determination method of the first embodiment, the determination method of the second embodiment, and the determination method of the third embodiment may be executed in parallel. For example, if it is determined that accumulation and analysis are required to be executed through at least one of the three determination methods, the accumulation and analysis may be executed.

### Fourth Embodiment

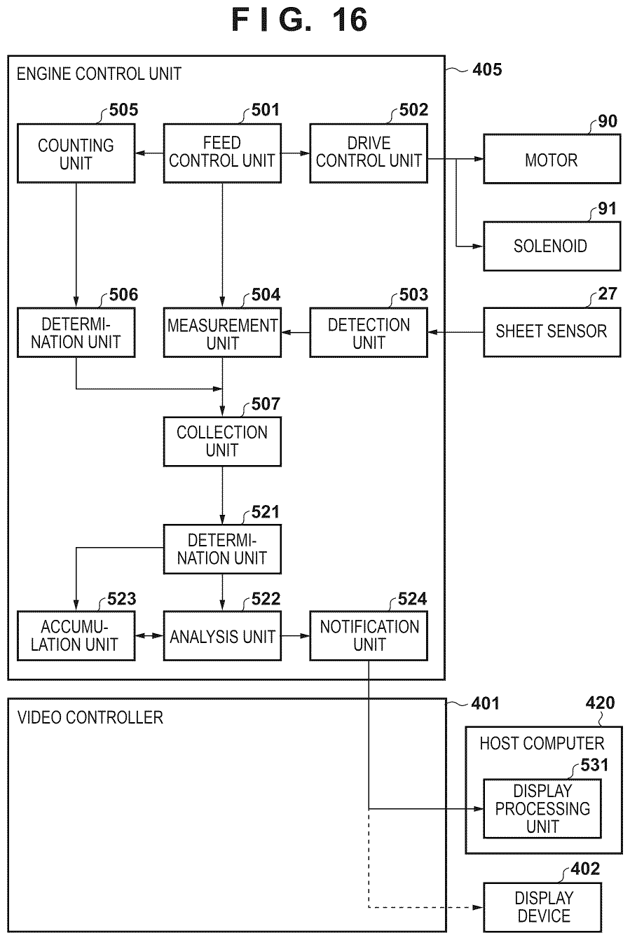

Although the first to third embodiments described the server apparatus 430 as being installed outside the printer 100, this is merely one example. As illustrated in FIG. 16, the functions of the server apparatus 430 may be implemented in the printer 100. In this example, the determination unit 521, the analysis unit 522, the accumulation unit 523, and the notification unit 524 are implemented by the CPU 80. In other words, the processing described as being executed by the CPU 87 of the server apparatus 430 in the first to third embodiments is executed by the CPU 80 of the engine control unit 405. The information described as being stored in the storage device 88 of the server apparatus 430 is stored in the storage device 81 of the engine control unit 405. The notification unit 524 may notify the host computer 420 of the response details via the video controller 401. The notification unit 524 may display the response details on the display device 402 via the video controller 401.

The accepting unit 902 and the saving unit 903 described with reference to FIGS. 9 and 14 may also be implemented by the CPU 80 of the engine control unit 405. The display device 402 and the input device 403 of the printer 100 may be used instead of the display device 84 and the input device 85 of the host computer 420.

### Other

The CPU 80 and the CPU 87 are examples of at least one processor. The CPU 80, the CPU 87, the communication circuit 89, and the determination unit 521 function as an obtainment unit. The CPU 80, the CPU 87, the storage device 88, and the accumulation unit 523 function as an accumulation unit. The CPU 80, the CPU 87, and the determination unit 521 function as a determination unit. The CPU 80, the CPU 87, and the analysis unit 522 function as an analysis unit. The CPU 80, the CPU 87, and the notification unit 524 function as a notification unit. This reduces the operation cost of the image forming system that executes the analysis of the operation history.

The determination unit 506 or the determination unit 521 may determine whether the operation history is to be accumulated on the basis of data associated with the printer 100. The accumulation unit 523 accumulates the operation history in accordance with the result of the determination. This reduces the operation cost of the image forming system that executes the accumulation of the operation history.

Information pertaining to the usage status or lifespan of a replacement component, the expiration date, the warranty period, and whether the image forming apparatus has a supplemental maintenance service is merely a list of examples of the data associated with the printer 100. The number of sheets or pages on which images have been formed, the amount of developing agent used to form the images on the sheets, the conveyance information pertaining to the conveyance time of the sheets to be measured, the number of times a jam has occurred, and the number of specific anomalous events that have occurred is merely a list of examples of the usage status of the replacement component (the consumable component), a consumption status, or correlation information correlated therewith.

As illustrated in FIG. 6A, the first threshold may be 199,000. The second threshold may be 200,000. The difference between the first threshold and the second threshold may be correlated with the number of data samples required for analysis.

As described in the second embodiment, the warranty period may be managed in association with the identification information of the printer 100. Accordingly, whether the accumulation and analysis can be executed may be determined on the basis of the warranty period (expiration date). The identification information may be unique information such as a printer ID, a production number, or a serial number. As described in the third embodiment, the product model of the printer 100 may be supplemented by a maintenance service (support). Accordingly, whether the accumulation and analysis can be executed may be determined on the basis of the maintenance information. The model information is an example of unique identification information for distinguishing product models.

The CPU 80, the CPU 87, the CPU 83, and the setting unit 901 may function as a setting unit that sets an analysis execution condition. The CPU 80, the CPU 87, the CPU 83, and the setting unit 901 may function as a setting unit that sets an accumulation execution condition. The CPU 80, the CPU 87, the CPU 83, and the setting unit 901 may set a notification frequency for the analysis result as data associated with the printer 100. The determination unit 506 and the determination unit 521 may execute the analysis at an execution interval according to the set notification frequency.

The data associated with the printer 100 may include one or more pieces of information that can be used to determine whether to execute the analysis. The determination unit 506 and the determination unit 521 may specify information to be used to determine whether to execute the analysis in accordance with a priority set in advance for the plurality of pieces of information.

The date/time field and the analysis instruction described in the first embodiment are examples of instruction information. The analysis instruction may be indicated by information stored in a predetermined field (e.g., the date/time field). The date/time field and the accumulation instruction described in the first embodiment are examples of instruction information. The accumulation instruction may be indicated by information stored in a predetermined field (e.g., the date/time field).

The communication unit 511 and the collection unit 507 are examples of a sending unit. The determination unit 521 is an example of a first determination unit. The determination unit 506 is an example of a first determination unit. As described in the first embodiment, the number of times the server apparatus 430 accumulates and analyzes the operation history may be reduced by a primary determination made in the printer 100.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-118761, filed Jul. 24, 2024 which is hereby incorporated by reference herein in its entirety.

What is claimed is:

1. An image forming system comprising:
at least one processor configured to obtain an operation history of an image forming apparatus and data pertaining to a state or a type of the image forming apparatus; and
a storage device configured to accumulate the operation history and the data obtained,
wherein the at least one processor is further configured to:
determine, based on the data, whether to execute an analysis using the operation history accumulated in the storage device;
execute the analysis in a case where the analysis is determined to be executed, and skip the analysis in a case where the analysis is determined not to be executed; and
provide a notification of an analysis result that is a result of the analysis.

2. The image forming system according to claim 1,
wherein the at least one processor is further configured to determine, based on the data, whether the obtained operation history is to be accumulated in the storage device, and
in a case where the at least one processor determines that the operation history is to be accumulated, the storage device accumulates the operation history.

3. The image forming system according to claim 2,
wherein the at least one processor is further configured to:
determine that it is necessary to accumulate the operation history and that it is not necessary to analyze the operation history in a case where a value indicated by the data is at least a first threshold and less than a second threshold; and
determine that it is necessary to accumulate the operation history and that it is also necessary to analyze the operation history in a case where the value indicated by the data is at least the second threshold.

4. The image forming system according to claim 2,
wherein the at least one processor is further configured to:
set an execution condition for accumulation of the operation history; and
determine whether to execute the accumulation of the operation history, based on the data and the execution condition.

5. The image forming system according to claim 2,
wherein the data includes instruction information instructing the operation history to be accumulated, the instruction information being received from the image forming apparatus.

6. The image forming system according to claim 5,
wherein a predetermined field of the data being empty indicates that the analysis should not be accumulated.

7. The image forming system according to claim 1,
wherein the data includes or is associated with at least one of the following:
a usage status or a lifespan of a replacement component constituting the image forming apparatus;
an expiration date set in the image forming apparatus;
a warranty period set in the image forming apparatus; and
information pertaining to whether the image forming apparatus has a supplemental maintenance service.

8. The image forming system according to claim 7,
wherein the usage status of the replacement component constituting the image forming apparatus includes at least one of the following:
a number of sheets or pages on which an image has been formed by the image forming apparatus;
an amount of a developing agent used to form images on sheets in the image forming apparatus;
conveyance information pertaining to a conveyance time of sheets, measured by the image forming apparatus;
the number of times a jam has occurred in the image forming apparatus; and
the number of times a specific anomalous event has occurred in the image forming apparatus.

9. The image forming system according to claim 7,
wherein the data includes identification information of the image forming apparatus associated with an expiration date set in the image forming apparatus or a warranty period set in the image forming apparatus, and
the at least one processor is further configured to:
obtain the expiration date or the warranty period associated with the identification information received from the image forming apparatus; and
determine that the analysis is to be executed in a case where the expiration date or the warranty period has not been reached, and determine that the analysis is to be skipped in a case where the expiration date or the warranty period has been reached.

10. The image forming system according to claim 9,
wherein the identification information is identification information for distinguishing each of a plurality of image forming apparatuses.

11. The image forming system according to claim 7,
wherein the data includes maintenance information pertaining to whether the image forming apparatus has the supplemental maintenance service, and
the at least one processor is further configured to:
obtain the maintenance information associated with identification information of the image forming apparatus received from the image forming apparatus; and
determine whether the image forming apparatus is subject to the maintenance service, based on the maintenance information.

12. The image forming system according to claim 11,
wherein the identification information is identification information for distinguishing a product model of the image forming apparatus.

13. The image forming system according to claim 1,
wherein the at least one processor is further configured to:
set an execution condition for the analysis; and
determine whether to execute the analysis, based on the data and the execution condition.

14. The image forming system according to claim 1,
wherein the data includes a frequency of notifications of the analysis result associated with identification information received from the image forming apparatus, and
the at least one processor is further configured to determine that the analysis is to be executed at an execution interval that is based on the frequency of the notifications of the analysis result.

15. The image forming system according to claim 1,
wherein the data includes one or more pieces of information that can be used to determine whether to execute the analysis, and
the at least one processor is further configured to, in a case where the data includes a plurality of pieces of information, specify information to be used to determine whether to execute the analysis in accordance with a priority set in advance for the plurality of pieces of information.

16. The image forming system according to claim 1,
wherein the data includes instruction information instructing the analysis to be executed, the instruction information being received from the image forming apparatus.

17. The image forming system according to claim 16,
wherein a predetermined field of the data being empty indicates that the analysis should not be executed.

18. A server computer comprising:
at least one processor configured to obtain an operation history of an image forming apparatus and data pertaining to a state or a type of the image forming apparatus; and
a storage device configured to accumulate the operation history and the data obtained,
wherein the at least one processor is further configured to:
determine, based on the data, whether to execute an analysis using the operation history accumulated in the storage device;
execute the analysis in a case where the analysis is determined to be executed, and skip the analysis in a case where the analysis is determined not to be executed; and
provide a notification of an analysis result that is a result of the analysis.

19. An image forming apparatus capable of communicating with a server apparatus analyzing an operation history of the image forming apparatus, the image forming apparatus comprising:
a consumable component consumed by forming an image;
at least one processor configured to:
obtain correlation information correlated with a consumption state of the consumable component;
collect an operation history of the consumable component; and
determine whether the operation history is to be sent to the server apparatus, based on the correlation information, and
a sending unit configured to send the operation history and data pertaining to a state or a type of the image forming apparatus to the server apparatus,
wherein the sending unit is configured to, in accordance with a result of the determination by the at least one processor:
skip sending the operation history and the data;
send the operation history and the data including an instruction to accumulate the operation history to the server apparatus; or
send the operation history and the data including an instruction to accumulate the operation history and an instruction to analyze the operation history to the server apparatus.
